(19) United States
(12) Patent Application Publication
(10) Pub. No.: US 2010/0258658 A1
(43) Pub. Date: Oct. 14, 2010

(54) Water outlet coupler

(76) Inventors: Dale Christensen, Arlington, NE (US); John Kastl, Wahoo, NE (US); Ricky D. McGee, Gretna, NE (US); Dennis R. Theilen, Omaha, NE (US)

Correspondence Address: THOMTE LAW OFFICE, L.L.C., 2120 S. 72ND STREET, SUITE 1111, OMAHA, NE, 68124, US

(21) Appl. No.: 12/384,859

(22) Filed: Apr. 9, 2009

(51) Int. Cl. B05B 3/00; F16L 39/02

(52) U.S. Cl. 239/723; 137/798

(57) ABSTRACT

A coupler is provided for an irrigation system wherein the coupler is mounted in the bottom of the water supply pipe rather than at the top of the water supply pipe with the upper end of the coupler projecting sufficiently upwardly within the water supply pipe to prevent debris from entering the interior thereof. A modified form of the invention is also disclosed.

### BACKGROUND OF THE INVENTION

1. Field of the Invention

This invention relates to a water outlet coupler for the water supply pipe of an irrigation system and more particularly to a water outlet coupler which is mounted at the bottom of the water supply pipe of a mechanized irrigation system. Even more particularly, this invention relates to a water outlet coupler which is mounted to the bottom of the water supply pipe of a center-pivot irrigation pipe and which has a riser tube projecting upwardly into the water supply pipe.

2. Description of the Related Art

In the past, irrigation systems such mechanized irrigation systems have used water outlets on the top of the water supply pipe in order to prevent debris in the irrigation water from plugging the small passages in the sprinklers attached to the outlet. The sprinklers were mounted on the top of the water supply pipe because debris typically settles in the bottom of the pipe and slides along the bottom of the pipe with the irrigation water. Debris is removed from the irrigation pipe through a series of flush-outs and drains located on the bottom of the pipe at regular intervals. Typically, a flush-out is located at the end of the machine and drains are located at each end of the spans.

Previous attempts using bottom-mounted couplers have not been successful because the debris in the irrigation water would easily plug the sprinklers attached to the outlet, resulting in poor water distribution along the machine and higher maintenance costs involved in the removal of the debris from the sprinklers.

Top-mounted water outlets were acceptable in the past because impact-type sprinklers were mounted on the top of the outlet. However, in order to minimize the evaporation losses, nearly all center pivot irrigation systems use a sprinkler hung well below the span, typically within the crop canopy. This sprinkler is attached to the top-of-the-pipe water outlet or coupler by means of a U-shaped pipe and a drop made from pipe or hose. The U-pipe is costly and adds complexity to the sprinkler plumbing.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A water outlet or coupler is disclosed for use on the bottom of a water supply pipe of an irrigation system to prevent debris from the irrigation system plugging the small passages in the sprinklers attached to the outlet. The coupler of this invention comprises a substantially vertically disposed tube having an upper end portion with an upper end and a lower end portion with a lower end. The upper end of the upper end portion of the tube has a water inlet formed therein with the lower end of the lower end portion of the tube having a water discharge opening formed therein. The upper end portion of the tube extends into the interior of the water supply pipe so that the water inlet opening of the tube is spaced above the bottom of the water supply pipe to prevent debris, which is moving within the water supply pipe, from entering the water inlet opening of the upper end portion of the tube.

The lower end portion of the tube may have a hose barb configuration or threads so that a sprinkler drop tube may be secured thereto with the sprinkler drop tube having a sprinkler at the lower end thereof.

In the preferred embodiment, the coupler includes a flared stop, which is positioned thereon intermediate the upper and lower end portions of the tube adjacent the exterior surface of the bottom of the water supply pipe and is preferably welded thereto.

In a second embodiment of the invention, a coupling is welded to the bottom of the water supply pipe at each of the openings formed therein. A pipe plug is threadably secured to the lower end of the coupling at locations where irrigating water is not needed or desired. Where irrigation water is needed, or desired, a fitting is threadably secured to the lower end of the coupling. Each of the fittings include a riser tube, having an upper water inlet end, which extends upwardly through the coupling, through the associated opening in the water supply pipe into the interior of the water supply pipe. The upper end of the riser tube is spaced well above the bottom of the water supply pipe to prevent debris from entering the riser tube. The fitting has a water discharge tube extending downwardly therefrom to which a drop tube is secured.

It is therefore a principal object of the invention to provide an improved coupler which is positioned at the bottom of a water supply pipe and which has a tube extending upwardly into the interior of the pipe so that debris moving with the water and the water supply pipe does not enter the interior of the tube.

A further object of the invention is to provide a coupler of the type described which eliminates the need of a U-shaped pipe which normally would extend from the top of the water supply pipe or connection to a drop tube.

Still another object of the invention is to provide a coupler or water outlet which eliminates the plugging of sprinklers connected to the drop tube associated therewith.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a partial perspective view of a center pivot irrigation system of the prior art wherein U-shaped pipes are connected to the top of the water supply pipe;

FIG. 2 is a partial perspective view of a center pivot irrigation system wherein the coupler of this invention is utilized;

FIG. 3 is a perspective view of the coupler of this invention having a hose barb structure at its lower end;

FIG. 4 is a side elevational view of the coupler of, FIG. 3;

FIG. 5 is a view similar to FIG. 3 except that pipe threads are provided on the lower end portion of the coupler rather than hose barbs;

FIG. 6 is an exploded perspective view illustrating the manner in which the coupler of this invention is inserted into the bottom of a water supply pipe;

FIG. 7 is a sectional view illustrating the coupler of this invention installed an opening in the bottom of a water supply pipe;

FIG. 8 is a perspective view of a modified form of the invention; and

FIG. 9 is a partial sectional view illustrating the embodiment of FIG. 8 mounted in an internally threaded coupling which is secured to the bottom of the water supply pipe.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

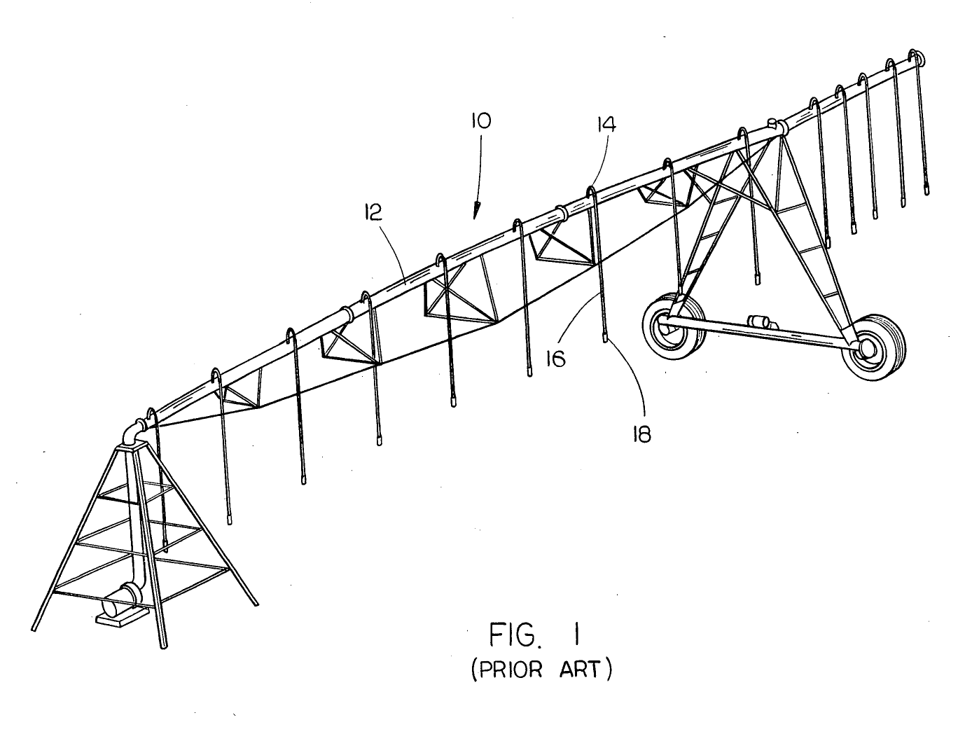

FIG. 1 partially illustrates a typical center irrigation span which is referred to generally by the reference numeral 10 wherein couplers are mounted on the top of the water supply pipe 12 which have U-shaped pipes extending therefrom having drop tube 16 connected thereto which has sprinklers 18 on the lower ends thereof. As stated above, the use of the U-shaped pipes 14 adds to the cost of the system and adds complexity to the sprinkler plumbing.

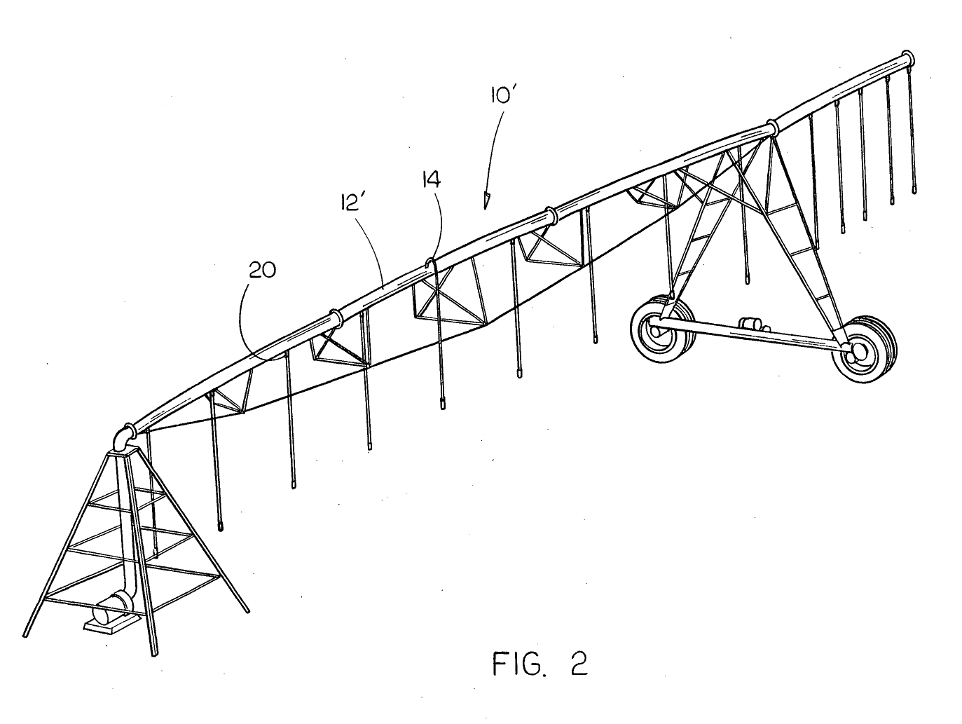

In FIG. 2, a center pivot irrigation system 10′ is illustrated but which has the couplers of this invention mounted on the bottom of the water supply pipe 12′. As will be described hereinafter, in some cases, a prior art U-shaped pipe 14 may be used at the uppermost portion of the water supply pipe 12′ to vent air therefrom during the filling of the system.

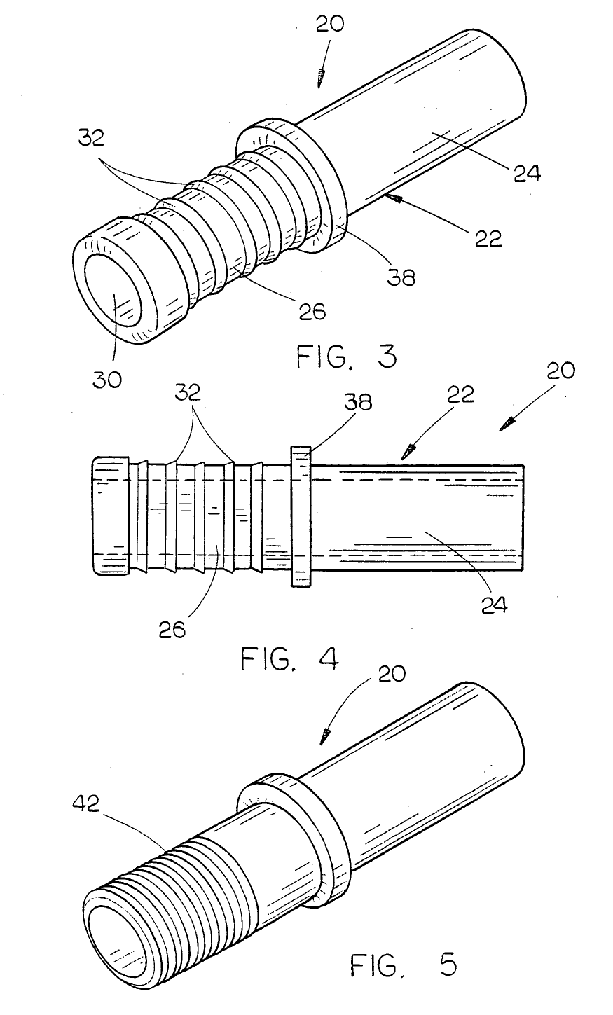

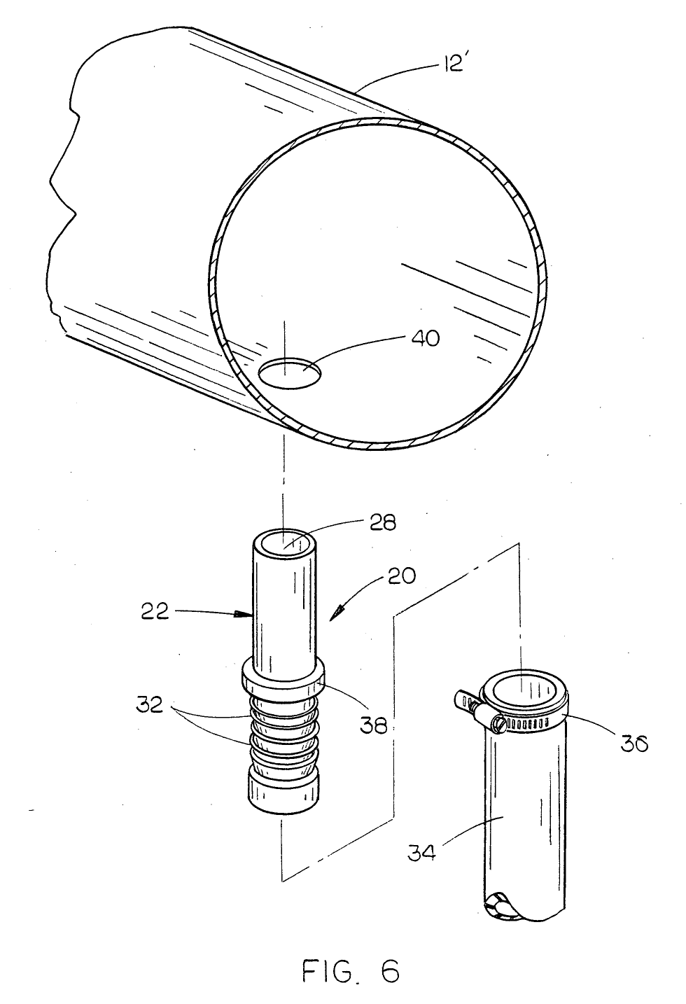

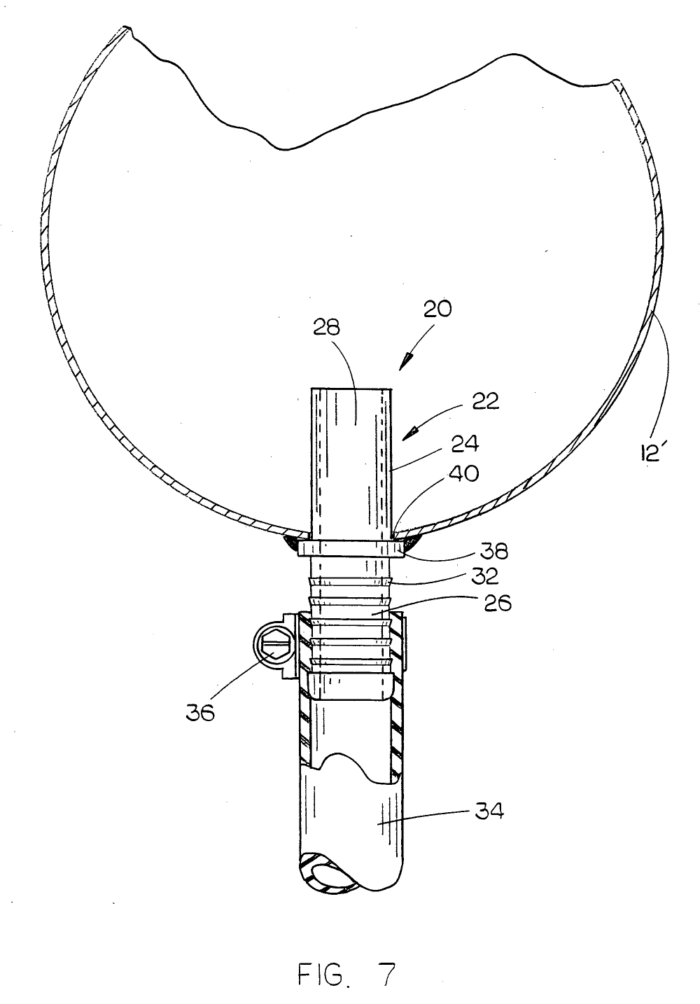

The coupler 20 illustrated in FIGS. 3, 4, 6 and 7 includes a tube 22 having an upper end portion 24 and a lower end portion 26. For purposes of description, tube 22 will be described as having a water inlet opening 28 at its upper end and a water discharge opening 30 provided at its lower end. The lower end portion 26 of tube 22 includes hose barbs 32 formed thereon to enable a drop tube 34 to be mounted thereon and held thereon by means of a clamp 36. Tube 22 is preferably provided with a flared stop 38 which extends outwardly therefrom as seen in the drawings.

The water supply pipe 12′ includes a plurality of longitudinally spaced-apart openings 40 formed therein at the bottom thereof. The coupler 20 is mounted on the water supply pipe 12 by inserting the upper end portion 22 of coupler 20 upwardly through the opening 40 until the stop 38 engages the exterior surface of the pipe 12′. The stop 38 is then welded to the exterior surface of the pipe 12. Although it is preferred that the coupler 20 be welded to the pipe 12′, the coupler 20 may be attached to the pipe 12′ by any convenient manner. The pipe 12′ and coupler 20 may be of any material but are typically steel. The pipe 12′ and the coupler 20 are typically hot-dipped galvanized for corrosion protection.

The shape of the upper end portion 24 is typically round, but may be of any shape, including an airfoil shape to minimize friction pressure loss in the pipe 12′. The shape or angle of the top of the tube 22 may be of any convenient design, but is typically parallel to the flow of the water.

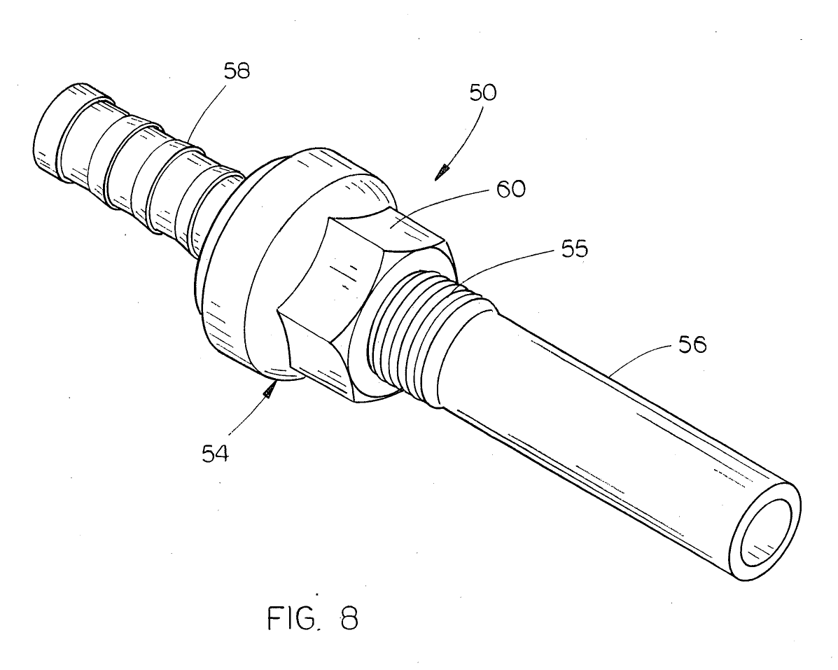

As seen in FIG. 7, the upper end of the upper end portion 24 is spaced a considerable distance from the bottom of the pipe 12′. The coupler tube 22 projects into the pipe 12′ a sufficient distance to prevent debris sliding along the bottom of the pipe 12′ from entering the coupler and plugging the attached sprinkler.

FIG. 5 illustrates a modified form of the coupler with the only difference being between that shown in FIG. 5 and that shown in FIG. 3 is that the hose barbs 32 have been replaced by pipe threads 42 so that the drop tube may be threadably secured thereto. The threads 42 may be external or internal.

Those systems utilizing couplers on the bottom of the water supply pipe will either require a single coupler on the top of the pipe as illustrated in FIG. 2 or modifying a coupler 20 having an upper end portion which has a greater length than that shown in the drawings so that the intake end of the upper end portion of the coupler will be closely positioned adjacent the interior surface of the pipe 12 so that air in the pipe may be vented therefrom when the span is filled with water at the start of irrigation. Trapped air can act as a flow restriction in the pipeline causing increased machine pressure loss.

Thus, it can be seen that a novel coupler has been provided for an irrigation system which eliminates the need of the costly U-shaped pipes 14 and which simplifies the sprinkler plumbing. It can also be seen that a unique coupler has been provided which prevents debris from entering the interior of the coupling due to the location of the upper end of the coupler well above the bottom of the pipe so that debris will not plug the sprinklers associated with the drop tubes.

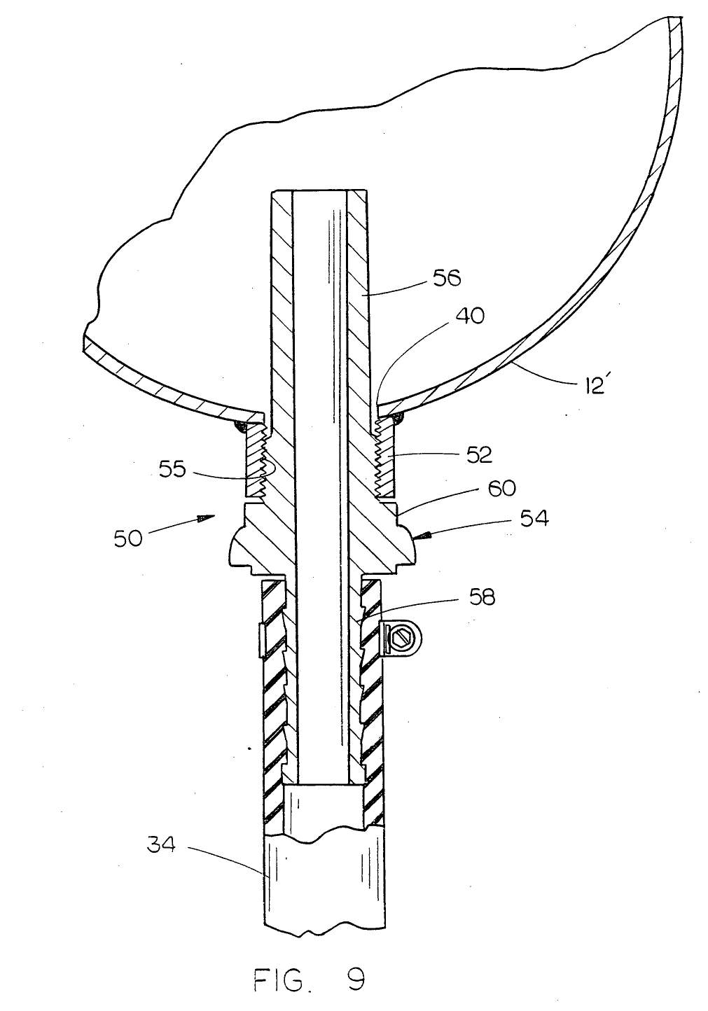

A modified form of the invention is illustrated in FIGS. 8 and 9 and is referred to generally by the reference numeral 50. As seen in FIG. 9, an internally threaded coupling 52 has its upper end secured to the water supply pipe 12′ at each of the openings 40 by any convenient means such as by welding or the like. The numeral 54 refers to a riser pipe fitting which has a threaded portion 55 threadably secured to the lower end of the coupling 52. A riser pipe or tube 56 extends upwardly from fitting 54 through the associated coupling 52, through opening 40 into the interior of the water supply pipe 12′. Fitting 54 has means 58 provided thereon adapted to have a drop tube 34 attached thereto. Means 58 may be of the hose barb type such as seen in FIGS. 8 and 9 or of the threaded type such as seen in FIG. 5. Fitting 54 includes wrench flats 60 to facilitate the threadable attachment of fitting 54 to coupling 52.

It may not be necessary or desirable to provide a fitting 54 at each of the couplings 52 along the length of the water supply pipe 12′ to irrigate a particular part of the field. In that case, a conventional pipe plug will be threadably secured to the coupling 52 to seal the lower end thereof.

It can therefore be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. In combination:
an overhead elongated water supply pipe, having opposite ends;
said water supply pipe having an exterior surface, an interior surface, a bottom and a top;
said water supply pipe having a plurality of longitudinally spaced-apart openings formed in the bottom thereof;
and a drop tube coupler sealably mounted on each of said spaced-apart openings;
each of said couplers comprising a substantially vertically disposed tube having an upper end portion with an upper end and a lower end portion with a lower end;
said upper end of said upper end portion of said tube having a water inlet opening formed therein;
said lower end of said lower end portion of said tube having a water discharge opening formed therein;
said upper end portion of said tube extending into the interior of said water supply pipe so that said water inlet opening of said tube is spaced above said bottom of said water supply pipe to prevent debris, which is moving within said water supply pipe, from entering said water inlet opening of said upper end portion of said tube;
said lower end portion of said tube adapted to have a sprinkler drop tube secured thereto.

2. The combination of claim 1 wherein said lower end portion of said tube has a threaded portion thereon;

3. The combination of claim 1 wherein said lower end portion of said tube has a hose barb structure thereon.

4. The combination of claim 1 wherein each of said couplers includes a stop positioned thereon intermediate said upper and lower end portions of said tube which is positioned adjacent the exterior surface of said bottom of said water supply pipe.

5. The combination of claim 4 wherein said stop is secured to said bottom of said water supply pipe.

6. The combination of claim 4 wherein said stop is welded to said bottom of said water supply pipe.

7. The combination of claim 1 wherein one of said couplers has an upper end which is positioned adjacent the upper interior surface of said top of said water supply pipe to vent air in said water supply pipe through said coupler.

8. The combination of claim 7 wherein the said one coupler is located at the highest point of said water supply pipe to remove air therefrom.

9. A coupler for attaching a drop tube or sprinkler to an opening formed in the bottom of a water supply pipe of a mechanized irrigation system; comprising:
a substantially vertically disposed tube having an upper end portion with an upper end and a lower end portion with a lower end;
said upper end of said upper end portion of said tube having a water inlet opening formed therein;
said lower end of said lower end portion of said tube having a water discharge opening formed therein;
said upper end portion of said tube extending into the interior of said water supply pipe so that said water inlet opening of said tube is spaced above said bottom of said water supply pipe to prevent debris, which is moving within said water supply pipe, from entering said water inlet opening of said upper end portion of said tube;
said lower end portion of said tube adapted to have a sprinkler drop tube secured thereto.

10. The coupler of claim 9 wherein said lower end portion of said tube has a threaded portion thereon so that the sprinkler or drop tube may be threadably secured thereto.

11. The coupler of claim 9 wherein said lower end portion of said tube has a hose barb structure thereon so that the sprinkler or drop tube may be clamped thereto.

12. The coupler of claim 9 wherein said coupler includes a stop positioned thereon between said upper and lower end portions of said tube which is positioned adjacent the exterior surface of said bottom of said water supply pipe.

13. The coupler of claim 12 wherein said stop is secured to said bottom of said water supply pipe.

14. The coupler of claim 12 wherein said stop is welded to said bottom of said water supply pipe.

15. The coupler of claim 9 wherein one of said couplers has an upper end which is positioned adjacent the upper interior surface of said top of said water supply pipe to vent air in said water supply pipe through said coupler.

16. The coupler of claim 15 wherein the said one coupler is located at the highest point of said water supply pipe to remove air therefrom.

17. In combination:
an irrigation system including an elongated water supply pipe, having opposite ends;
said water supply pipe having an exterior surface, an interior surface, a bottom and a top;
said water supply pipe having a plurality of longitudinally spaced-apart openings formed in the bottom thereof;
an internally threaded coupling sealably mounted on said water supply pipe at each of said spaced-apart openings;
each of said couplings having upper and lower ends with the upper end thereto secured to the bottom of said water supply pipe;
each of said couplings having either a pipe plug threadably secured thereto which plugs the lower end thereof or a riser pipe fitting threadably secured thereto;
each of said riser pipe fittings having upper and lower ends with a central water passageway extending therethrough;
each of said riser pipe fittings having a riser pipe, having an upper water inlet opening and lower water discharge end, extending upwardly therefrom through the associated coupling into the interior of said water supply pipe;
said upper end of said riser pipe extending into the interior of said water supply pipe so that said water inlet opening of said riser pipe is spaced above said bottom of said water supply pipe to prevent debris, which is moving within said water supply pipe, from entering said water inlet opening of said upper end portion of said tube;
said lower end of each of said fittings having means associated therewith which is adapted to have a sprinkler drop tube secured thereto.

18. The combination of claim 17 wherein said means on said lower end of each of said fittings comprises a discharge tube having hose barbs thereon.

19. The combination of claim 17 wherein said means on said lower end of each of said fittings comprises a discharge tube having threads.
